(19) United States
(12) Patent Application Publication
(10) Pub. No.: US 2021/0223396 A1
(43) Pub. Date: Jul. 22, 2021

(54) MULTIPLE MIRROR MONOSTATIC SCANNING LIDAR OPTICAL RANGING SENSOR

(71) Applicant: Lumibird Limited, Ontario (CA)

(72) Inventor: Derek BUTLER, Ontario (CA)

(73) Assignee: Lumibird Limited, Ontario (CA)

(21) Appl. No.: 17/055,207

(22) PCT Filed: May 14, 2018
(86) PCT No.: PCT/CA2018/050566

§ 371 Date: Nov. 13, 2020

(51) Int. Cl. G01S 17/42; G01S 7/481; G02B 26/10

(52) U.S. Cl. CPC G01S 17/42; G02B 26/10; G01S 7/4812; G01S 7/4817

(57) ABSTRACT

A scanning ranging sensor comprises first and second independently rotatable mirrors about respective axes. The first axis is at a first angle relative to a source's incident radiation beam axis and at a third angle relative to the second axis. The first mirror redirects the energy at a second angle to the first axis as it is rotated. The second minor further redirects the redirected energy at a fourth angle to the second axis as it is rotated, in a direction within the FOV, receives returned energy from a target and redirects it to the first minor to be further redirected toward an energy-redirecting element interposed between the source and the first mirror that allows unimpeded passage of the energy from the source, and redirects the returned energy to a detector. Correlating data from the detector with corresponding data from the source may determine the target range.

### RELATED APPLICATIONS

Not applicable.

### TECHNICAL FIELD

The present disclosure relates to scanning LIDARs and in particular to a multiple mirror monostatic scanning LIDAR optical ranging sensor.

### BACKGROUND

Optical ranging sensors for determining the profile of the surface of an object relative to a reference plane are known. In some aspects, such sensors are often used to determine the range from the sensor to the object. Typically, they involve the transmission of an optical launch beam for reflection by the object and measurement of a scattered return beam from which the range to the object may be calculated. One such system is Light Detection And Ranging (LIDAR). Some LIDAR ranging systems measures the time of flight (TOF) of a collimated optical launch beam (typically using laser pulses) and its scattered return beam.

Monostatic LIDAR sensors, in which the launch beam and return beam are co-aligned, are relatively simple in structure. A simple example non-scanning monostatic LIDAR sensor is schematically shown in FIG. 1, in which the sensor 1 includes a beam source 2, typically a pulsed laser, a first lens 3, a beam splitter 4, a second lens 6, a detector 7 and a receiver unit 11. A launch beam 8, which may be a laser beam, emanating from the beam source 2, passes through the first lens 3 and beam splitter 4, projecting the launch beam 8 onto a target 10, whose range is to be measured. The series of reflecting and refracting elements through which the launch beam 8 is passed is known as the sensor head.

The beam splitter 4 receives laser light reflected back from the target 10 and is arranged so that the component of the returned light 9 between the target 10 and the beam splitter 4 is co-aligned with the launch beam 8. Thus, the returned light 9 impinges upon the detector 7. The beam splitter 4 reflects the return beam 9 at some angle, which in some non-limiting examples may be 90°, onto the detector 7 via the second lens 6. The range is measured by a receiver unit 11 based on correlation of information between the launch beam 8 and the detected returned light 9. Where the launch beam 8 is pulsed, a TOF technique may be employed based on the time interval between the pulsed launch beam 8 and detected returned light 9 and knowledge of the speed of light. In some non-limiting examples, where the launch beam 8 is a continuous wave (CW) signal, a phase detection technique may be employed based on the heterodyne phase difference between the CW launch beam 8 and detected returned light 9. In some non-limiting examples, where the launch beam 8 is a CW signal, a triangulation technique may also be employed.

In some examples, the beam splitter 4 could be replaced by a (parabolic) mirror (not shown) facing the target 10, with a central aperture to allow the launch beam 8 to pass through it.

In some examples, three-dimensional sensing may be obtained, by mounting the sensor on a pan-tilt unit that is re-oriented from time to time so that the launch beam 8 is reflected off different locations on the surface of the target 10, or by interposing an optical scanner (not shown) between the beam splitter 4 and the target 10 to control the beam direction and direct the launch beam 8 along a two-dimensional grid (usually designated as comprising x- and y-coordinate values) substantially normal to the launch beam axis and defining a reference plane. In such examples, the z-coordinate, lying on an axis normal to the reference plane, measures the range for each (x,y) coordinate pair. In such an arrangement, the optical scanner also receives laser light reflected back from the target 10 and is arranged to maintain the co-aligned arrangement between the component of the returned light 9 and the launch beam 8 between the target 10 and the optical scanner, so as to ensure that the detector 7 images the returned light 9 regardless of scanning angle (a concept known as auto-synchronization).

The maximum angular direction, at which the launch beam 8 may be directed by the optical scanner while remaining auto-synchronized, defines the field of view (FOV) of the sensor. Generally, it is considered beneficial to have as large a FOV as possible.

Monostatic optics are often used in scanning LIDARs because of their relatively small mirror size. In some examples, it is beneficial to have as small a sensor package as possible. Moreover, in many applications for optical ranging sensors, the sensor is mounted on a moving platform, which may be ground-, underwater-, air- or even space-based, to detect objects in the platform's path or more generally, within its FOV, so as to allow the platform to be maneuvered toward, away or through the obstacles as desired or alternatively to map the environment in which the platform is operating.

However, because monostatic LIDAR sensors co-align the returned light 9 with the launch beam 8, there is a risk that blooming from imperfections in the path of the launch beam 8 especially at extremely short range, may, if it lies in the path of the receiving optics, saturate the detector 7, leading to anomalous range calculations. For this reason, monostatic LIDAR sensors typically do not detect the returned light 9 from targets 10 that are within a few meters range. Furthermore, because the power of the returned light 9 attenuates significantly as range increases, unless the detector 7 has an extremely high dynamic range, it also may not detect the returned light 9 if the target 10 is distant.

In computer vision applications, such as for navigation of a robot or an autonomous vehicle, a scanning LIDAR is often employed to acquire 3D imagery. In some example applications, such as mobile sensor applications, the specifications of such scanning LIDARs are challenging. In some example embodiments, the FOV may be specified to be substantially 360° in azimuth (in some example embodiments represented by the x-coordinate) by substantially 45° in elevation (in some example embodiments represented by the y-coordinate), with a resolution of 3 mrad (0.17°) in both the azimuthal and elevation directions.

Additionally, in some examples, the operational parameters in which the sensor 1 may be requested to operate may be challenging. For example, the frame rate may be specified to be on the order of 1 Hz and the maximum sensor range may be as much as 1 km.

Such specifications pose additional constraints on the design. For example, a scanning LIDAR having a 360° (azimuth)×45° (elevation) FOV with a resolution of 3 mrad, calls for a mesh of 548k sampling points (2094 points horizontally and 262 points vertically). If a frame rate of 1 Hz is specified, the sensor will have a minimum data rate of 548 kHz.

In some examples, the scanning LIDAR sensor may be further constrained to occupy a small volume and have a small weight with low power consumption.

Typically, to provide a sensor with a 360° azimuthal FOV, some sort of spinning mechanism is incorporated as, or in place of, the pan-tilt or scanning mechanism, or both. A number of systems capable of providing such a FOV are known.

One such system is described in US Patent Application Publication No. 2005/0246065 filed by Ricard on 3 May 2005 and published 3 Nov. 2005 and entitled “Volumetric Sensor for Mobile Robotics”. The sensor is a volumetric sensor for mobile robot navigation to avoid obstacles in the robot's path and includes a laser volumetric sensor on a platform with a laser and detector directed to a tiltable mirror in a first transparent cylinder that is rotatable through 360° by a motor, a rotatable cam in the cylinder tilts the mirror to provide a laser scan and distance measurements of obstacles near the robot. A stereo camera is held by the platform, that camera being rotatable by a motor to provide distance measurements to more remote objects.

The Ricard sensor employs a short range off-the-shelf laser ranging system capable of providing measurements of less than substantially 50 m. The laser ranging system scans only 33 lines vertically in a 360° helical scan pattern in 1s. Additionally, the scanning mechanism, employing a tiltable mirror, a protective cover and a window that is rotated with the mirror, is complex and may not be amenable to an increased scan rate.

Another such system is provided by Velodyne Lidar Inc. of Morgan Hill, Calif. The Velodyne model HDL-64 High Definition LiDAR is commonly found in autonomous vehicles. In the Velodyne system, the entire head, consisting of both scanning optics and electrical system) is spun. The scanning optics employs 64 pairs of lasers and detectors. Such a design employs special designs to pass data (at a rate of 1.3 M points per second) and power to the spinning head, which rotates at substantially 15 revolutions per second. The large number of pairs of lasers and detectors significantly affects the cost of the device.

Moreover, the Velodyne sensor spans only 64 lines in the vertical direction and has a short maximum range of substantially 120 m.

U.S. Pat. No. 4,871,904 issued 3 Oct. 1989 to Metlitsky et al and entitled “Multidirectional Optical Scanner” discloses a multidirectional scan pattern that is generated by two mirrors, each inclined at a tilt angle and rotated about an axis at an angular speed. The size and shape of the pattern are controlled by adjusting the tilt angles and the angular speeds.

The Metlitsky scanner acts as a bar code scanner and uses a continuous beam of energy with a faceted or oscillating element. The scan pattern has a void in the middle. Given the purpose for which the Metlitsky scanner is employed, this is in fact desirable, especially given that the energy is emitted in a continuous beam, because the void reduces the risk that the scanner will radiate energy at a customer's eye.

U.S. Pat. No. 7,336,407 issued 26 Feb. 2008 to Adams et al. and entitled “Scanner/Pointer Apparatus having Super-Hemispherical Coverage” discloses a scanner apparatus which has super-hemispherical coverage and includes a receiver, a pair of counter-rotating prisms, and a rotating mirror aligned with the pair of counter-rotating prisms. The rotating mirror and the pair of counter-rotating prisms guide an observed optical signal in a field of regard greater than that achievable through the use of only the pair of counter-rotating prisms. The apparatus may also include a laser that generates an optical signal guided by the prisms and the mirror toward an object of interest in the field of regard.

The prisms in the Adams et al apparatus are constrained in that they rotate in opposite directions and the rotational speed of one of the prisms is a function of the rotational speed of the other prism, that is, the prisms are not independently rotatable.

PCT International Patent Application Publication No. WO2013/177650 filed by Neptec Design Group Ltd. (“NDG”) on 26 Apr. 2012 and entitled “High Speed 360 Degree Scanning LIDAR Head” discloses a head for directing radiated energy from a source to a target at a coordinate in a field of view defined by at least one of azimuth and elevation, that comprises an angled element and a planar reflecting element. The angled element rotates about a first axis and redirects the beam, the redirection of the angled element differing in at least one of direction and extent as it is rotated. The reflecting surface rotates about a second axis parallel to the first. An axis normal to the surface extends at an angle to the second axis. The reflecting surface receives the redirected beam at a point thereon and reflects it in a direction within the FOV. A rotator may be positioned between the source and the angled element to support and independently rotate the angled element and the reflecting surface about the first and second axis without impeding the energy.

While the NDG LIDAR head has two rotating elements, an angled element and a planar reflecting element, that are independently rotatable, they are constrained in that the rotational axes of both elements are parallel and in some examples, co-axial.

The NDG LIDAR head accomplishes this by a dual hollow shaft rotator to independently rotate the angled element and the reflecting surface and to allow the energy to be radiated from the source through the hollow shaft of the rotator onto the angled element. The hollow shaft rotator imposes practical limits on the minimum and maximum size of the NDG LIDAR head. The minimum size of the head is constrained by the fact that the energy beam that is directed onto the target passes through the hollow shaft. Unduly reducing the size of the head, and concomitantly the diameter of the hollow shaft, reduces the effective intensity of the return pulse energy. Since the energy is scattered by the target upon which it impinges, and not all of it will be reflected back to the detector, the reduction in the effective return pulse energy may impair the ability of the detector to gather sufficient energy in order to estimate the range to the target. At the same time, the maximum size of the head is constrained by the fact that the angled element and the reflecting surface are mounted onto the rotator, and rotated thereby. Unduly increasing the size of the head, and concomitantly the diameter of the hollow shaft, increases not only the size of the angled element and the reflecting surface, but also the size of the rotator, and the load that will be borne by the motors driving them.

This background information is provided to reveal information believed by the applicant to be of possible relevance to the present invention. No admission is necessarily intended, nor should be construed, that any of the preceding information constitutes prior art against the present invention.

### SUMMARY

It is an object of the present disclosure to obviate or mitigate at least one disadvantage of the prior art.

According to a first broad aspect of the present disclosure, there is disclosed a head for directing energy radiated from a source along a beam axis to a coordinate in an FOV defined by at least one of azimuth and elevation, comprising first and second energy-redirecting elements. The first energy-redirecting element is rotatable about a first axis that is at a first angle relative to the beam axis. The first energy-redirecting element is for receiving the radiated energy incident thereon along the beam axis and redirecting it at a second angle to the first axis as it is rotated. The second energy-redirecting element is independently rotatable in at least one of direction and rate relative to the first energy-redirecting element about a second axis that is at a third angle relative to the first axis. The second energy-redirecting element is for receiving the redirected energy incident thereon and further redirecting it at a fourth angle to the second axis as it is rotated, in a direction within the FOV.

In an embodiment, the first angle can be substantially equal to the third angle. In an embodiment, the first angle can be substantially 45°. In an embodiment, the second angle can be substantially between 0° and 15°. In an embodiment, the third angle can be substantially 45°. In an embodiment, the fourth angle can be substantially between 0° and 15°.

In an embodiment, the second axis can lie in an azimuthal plane defined by the beam axis and the first axis.

In an embodiment, the FOV can extend substantially 60° in azimuth. In an embodiment, the FOV can extend substantially 40° in elevation.

In an embodiment, the second axis can be at a fifth angle relative to the plane. In an embodiment, the fifth angle can be substantially 45°. In an embodiment, the FOV can extend substantially 75° in at least one of azimuth and elevation.

In an embodiment, the first energy-redirecting element can be a first mirror surface. In an embodiment, the second energy-redirecting element can be a second mirror surface.

In an embodiment, the first energy-redirecting element can be independently rotatable in both direction and rate relative to the second energy-redirecting element.

In an embodiment, the energy can comprise a beam. In an embodiment, the beam can be a laser beam. In an embodiment, the beam can be pulsed.

In an embodiment, the energy from the source can pass unimpeded through an aperture in a third energy-redirecting element positioned between the source and the first energy-redirecting element.

In an embodiment, at least some of the energy redirected by the second energy-redirecting element can be returned and impinge upon the second energy-redirecting element to be redirected for impingement upon the first energy-redirecting element to be further redirected for impingement upon the third energy-redirecting element, whereupon it is redirected toward a detector.

In an embodiment, the third energy-redirecting element can be at least one of a third mirror surface and a refractive element. In an embodiment, the third mirror surface can be at least one of substantially planar and parabolic.

In an embodiment, the head can further comprise at least one of a filter and a focusing unit interposed between the third energy-redirecting element and the detector.

In an embodiment, the source and the detector can each be coupled to a receiving unit whereby data from the detector is correlated with corresponding data from the source to determine a range from the head to a target within the FOV upon which the energy redirected by the second energy-redirecting element has impinged and been returned to the head.

In an embodiment, the receiving unit can calculate the range to the target by at least one of TOF and phase difference.

According to a second broad aspect, there is disclosed a method of directing energy, radiated from a source along a beam axis, to a coordinate in an FOV defined by at least one azimuth and elevation, comprising actions of: rotating a first energy-redirecting element about a first axis that is at a first angle relative to the beam axis; directing the energy from the source onto the first energy-redirecting element; redirecting the energy incident on the first energy-redirecting element, at a second angle to the first axis, toward a second energy-redirecting element; independently rotating, in at least one of direction and rate relative to the first energy-redirecting element, the second energy-redirecting element about a second axis that is at a third angle relative to the first axis; and further redirecting the energy incident on the second energy-redirecting element, from the first energy-redirecting element, at a fourth angle to the second axis in a direction within the FOV.

Embodiments have been described above in conjunction with aspects of the present disclosure upon which they can be implemented. Those skilled in the relevant art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Some aspects and embodiments of the present disclosure may provide a dual mirror monostatic scanning LIDAR optical ranging sensor and a head therefor.

### BRIEF DESCRIPTION OF THE DRAWINGS

Example embodiments of the present disclosure will now be described by reference to the following figures, in which identical reference numerals in different figures indicate identical elements and in which:

FIG. 1 is a schematic diagram of a non-scanning monostatic LIDAR optical ranging sensor;

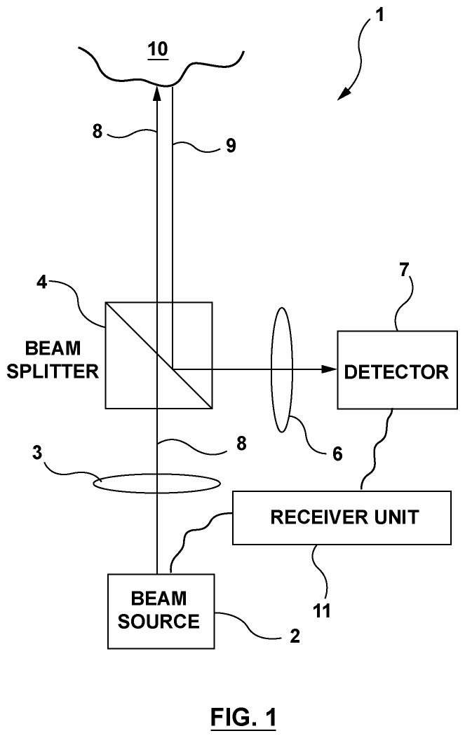

FIG. 2 is a plan schematic view of an example head for a multiple mirror monostatic scanning LIDAR optical ranging sensor according to an example;

FIG. 3 is an isometric view showing the sensor of FIG. 2 within an enclosure;

FIG. 4 is an isometric view showing the enclosure of FIG. 3 with an aperture cover and the FOV of the elliptical launch signal generated thereby;

FIG. 5 is a print out of an example of traces of a projection of the twice-reflected launch beam in the launch portion of the sensor of FIG. 2 after a small number of rotations of the first and second mirrors thereof;

FIG. 6 is a print out of an example of traces of a projection of the twice-reflected launch beam in the launch portion of the sensor of FIG. 2 after a larger number of rotations of the first and second mirrors thereof;

FIG. 7 is an isometric view showing the enclosure of FIG. 3 with the radiation source outside the enclosure;

FIG. 8 is a print out of a simulation, of traces of the output of a twice-reflected continuous wave launch beam in the launch portion of the sensor of FIG. 2, conducted using the parameters shown thereon;

FIG. 9 is a print out of a simulation, of traces of the output of a twice-reflected continuous wave launch beam in the launch portion of the sensor of FIG. 2, conducted using the parameters shown thereon;

FIG. 10 is a perspective schematic view of an example multiple mirror monostatic scanning LIDAR optical ranging sensor according to an example; and

FIG. 11 is an isometric view showing an enclosure for the sensor of FIG. 10 with an aperture cover and the FOV of the conic launch signal generated thereby.

In the present disclosure, for purposes of explanation and not limitation, specific details are set forth in order to provide a thorough understanding of the present disclosure. In some instances, detailed descriptions of well-known devices and methods are omitted so as not to obscure the description of the present disclosure with unnecessary detail.

Accordingly, the system and method components have been represented, where appropriate, by conventional symbols in the drawings, showing only those specific details that are pertinent to understanding the embodiments of the present disclosure, so as not to obscure the disclosure with details that will be readily apparent to those of ordinary skill in the art having the benefit of the description herein.

Any feature or action shown in dashed outline may in some example embodiments be considered as optional.

### DESCRIPTION

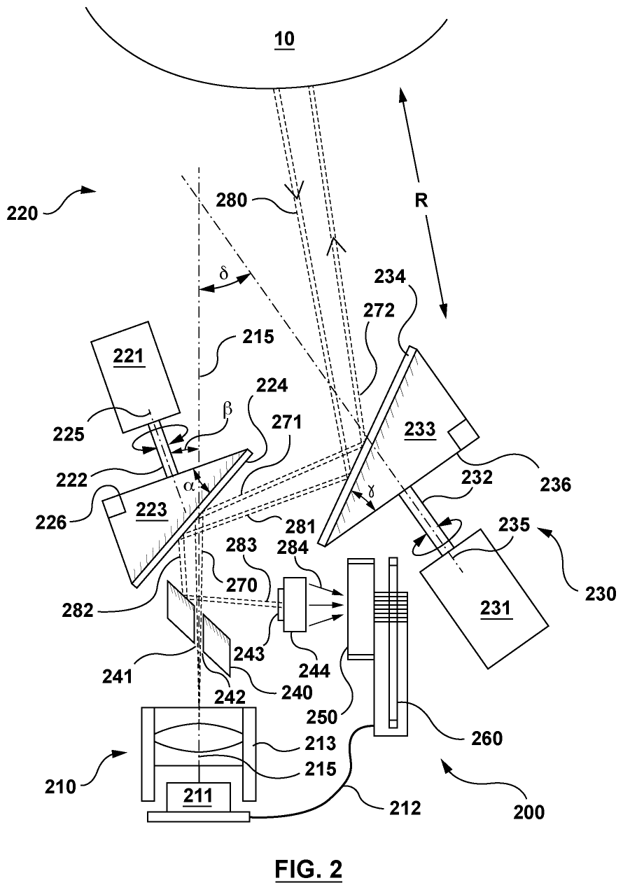

Turning now to FIG. 2, there is shown a plan schematic view of a first example of a head of a multiple mirror monostatic scanning LIDAR optical ranging sensor according to the present disclosure. The sensor, shown generally at 200, comprises a beam source 210, a first redirecting assembly 220, a second redirecting assembly 230, a third redirecting element 240, a detector 250 and a receiver unit 260.

The sensor 200 may be considered as comprising a launch portion and a detection portion. The launch portion of the sensor 200 may be considered to employ the beam source 210, the first redirecting assembly 220 and the second redirecting assembly 230. The detection portion of the sensor 200 may be considered to employ the first mirror assembly 220, the second mirror assembly 230, the third redirecting element 240, the detector 250 and the receiver unit 260.

Considering first the launch portion of the sensor 200, the beam source 210 generates a launch beam 270 of radiation emitted by a radiation source 211 along a beam axis 215.

In some non-limiting examples, the radiation source 211 may be a laser. In some examples, the radiation source 211 may be an LED laser. In some non-limiting examples, the wavelength of the launch beam 270 may be 1550 nm. In some non-limiting examples, the rated power of the radiation source 211 may be between substantially 300 mW and 2 W.

However, the radiation source 211 may be provided with a substantially larger (or smaller) rated power depending upon the desired range, capability and/or sensitivity of the sensor 200.

The ability to image a target 10 at a given range R of the sensor 200 may depend upon one or more of the rated power of the radiation source 211, the sensitivity of the detector 250 and/or how much power is returned from the target 10 and is redirected to the detector 250.

In some non-limiting examples, the wavelength of the launch beam 270 and/or the rated power of the radiation source 210 may be constrained by prevailing eye safety considerations.

In some non-limiting examples, the launch beam 270 is pulsed at a pulse repetition frequency (PRF) that may range, without limitation, from as low as 0 Hz (in the case of a CW beam) to a maximum capability supported by the sensor 200, recognizing that the effective range of the sensor 200 would decrease as the PRF increases. In some non-limiting examples, the beam 270 is a continuous beam. In some non-limiting examples, the beam 270 is a frequency modulation (FM) CW (FMCW) beam, especially if, as discussed below, heterodyne detection of the phase difference is used to determine the range Rto the target 10.

The beam source 210 is coupled to the receiver unit 260 by a signal line 212 such that the receiver unit 260 can correlate the emission of the launch beam 270 with the receipt of a signal corresponding thereto by the detector 250 and determine the range Rto the target 10 therefrom.

In some non-limiting examples, the time that the (pulsed) launch beam 270 is emitted is correlated with the time at which the corresponding signal is detected at the detector 250 to determine a time of flight (TOF) to and from the target 10 from which the range R thereto may be determined.

In some non-limiting examples, the phase at which the (CW) launch beam 270, which in some non-limiting examples would be a FMCW beam, is emitted is correlated with the phase at which the corresponding signal is detected by heterodyne detection at the detector 250 to determine a phase difference, from which the range R to the target 10 may be determined, although it will be appreciated that the specific configuration in such case would be different and may involve different and/or additional components from that shown in FIG. 2 and as described herein.

In some non-limiting examples, the beam source 210 comprises a collimator 213, for collimating the launch beam 270 passing through it, to restrict or inhibit its divergence from the beam axis 215. Additionally, in some non-limiting examples, the collimator 213 may expand the launch beam 270 to a diameter that is suitable so that its energy density is sufficiently low, relative to the rated power of the radiation source 210 and the wavelength(s) emitted, to satisfy prevailing eye safety considerations.

The first redirecting assembly 220 comprises a first motor 221, a first motor shaft 222, a first mirror mount 223 and a first redirecting element, which in some non-limiting examples, may be a first mirror surface 224. In some non-limiting examples, the first mirror surface 224 may be substantially circular in shape.

The first motor 221 is coupled to the first motor shaft 222 at a first end, and can rotate the first motor shaft 222 in at least one of the clockwise and counter-clockwise direction at a selectable rotation rate. In some non-limiting examples, the first motor 221 can rotate the first motor shaft 222 about a first axis 225 thereof in both the clockwise and counter-clockwise direction. In some non-limiting examples, the first motor shaft 222 may be rotated at a rate between substantially 0 and on the order of multiples of 10,000 rpm.

The first motor shaft 222 is coupled at a second end to a first base 226 of the first motor mount 223. In some non-limiting examples, the first base 226 of the first motor mount 223 defines a plane normal to the first axis 225 of the first motor shaft 222.

The first motor mount 223 supports the first mirror surface 224 thereon at an angle α to the base 226 of the first motor mount 223. In some non-limiting examples, the first motor mount comprises a prism-shaped structure having two identical right-angle triangle-shaped faces and three rectangular faces whose opposing sides are corresponding sides of the triangle. One of the rectangular faces adjacent to the right angle of the triangle forms the first base 226 of the first motor mount 223. The first mirror surface 224 is parallel to, supported by and coupled to the rectangular face opposite to the right angle of the triangle. The face opposite the right angle is thus at an angle α to the face that forms the first base 226 of the first motor mount 223, that is, at an angle (90−α) to the first axis 225. In some examples, the angle α may be in the range of substantially 0° to 15°. Using a larger angle may constrain the ability to reduce the size of the first mirror surface 224 and of a second mirror surface 234 (described below) and may adversely impact the amount of returned radiation 280 (described below) that may be captured by the sensor 200 for use by the detector 250.

The first axis 225 of the first motor shaft 222 and the beam axis of the launch beam 270 define a plane of the sensor 200. The first axis 225 of the first motor shaft 222 and the launch beam 270 define an acute angle β. In some non-limiting examples, the angle β is 45°.

The first mirror assembly 220 is positioned such that the launch beam 270, which exits the collimator 213 and proceeds unimpeded thereafter, including through the third redirecting element 240, impinges on the first mirror surface 224 at a central position thereof. Thus, as the first motor 221 rotates the first motor shaft 222, the first mirror surface 224 oscillates at the angle α about the first axis 225 of the first motor shaft 222, so that the launch beam 270 impinges upon the first mirror surface 224 and is reflected at an angle (90±α) relative to the first axis 225 in a first reflected launch beam 271. The amount of oscillation depends upon the angle α. The bearing of the first reflected launch beam 271 depends in part upon the instantaneous rotational angle of the first mirror surface 224. Over one revolution of the first motor shaft 222, the first reflected launch beam 271 describes a (pulsed) hollow-shell right ovoid-cone FOV.

In some non-limiting examples, the first redirecting element may be a refractive element (not shown) that causes the launch beam 270 to be refracted at an angle (90±α) relative to the first axis 225 in the first reflected launch beam 271.

Although the launch beam 270 always impinges on the same spot on the first mirror surface 224, the first mirror surface 224 is sized to ensure that a sufficient amount of the first reflected return column 281 (discussed below) from the second mirror surface 234 (discussed below) will be reflected thereon toward the third redirecting element 240 to permit detection and ranging of the target 10 as discussed below. The larger the angle γ of the second mirror surface 234, the larger will be the size of the first mirror surface 224. It will be appreciated that the distance between the second mirror surface 234 and the first mirror surface 224 may impact the size of the second mirror surface 224.

The second redirecting assembly 230 comprises a second motor 231, a second motor shaft 232, a second motor mount 233 and a second redirecting element, which in some non-limiting examples, may be a second mirror surface 234. In some non-limiting examples, the second mirror surface 234 may be substantially circular in shape.

In some non-limiting examples, the second redirecting assembly 230 is identical to and/or substantially similar to the first redirecting assembly 220, except for its positioning, and/or with perhaps the exception of the angle γ (corresponding to the angle α in the first redirecting assembly 220) and/or the angle δ (corresponding to the angle β in the first redirecting assembly 220).

The second motor 231 is coupled to the second motor shaft 232 at a first end and can rotate the second motor shaft 232 in at least one of the clockwise and counter-clockwise direction at a selectable rotation rate. In some non-limiting examples, the second motor 231 can rotate the second motor shaft 232 about a second axis 235 thereof in both the clockwise and counter-clockwise direction. In some non-limiting examples, the second motor shaft 232 may be rotated at a rate between substantially 0 and on the order of multiples of 10,000 rpm.

The first motor shaft 222 and the second motor shaft 232 are independently rotatable both in terms of speed and direction.

The second motor shaft 232 is coupled at a second end to a second base 236 of the second motor mount 233. In some non-limiting examples, the second base 236 of the second motor mount 233 defines a plane normal to the axis 235 of the second motor shaft 232.

The second motor mount 233 supports the second mirror surface 234 thereon at an angle γ to the second base 236 of the second motor mount 233. In some non-limiting examples, the second motor mount comprises a prism-shaped structure having two identical right-angle triangle-shaped faces and three rectangular faces whose opposing sides are corresponding sides of the triangle. One of the rectangular faces adjacent to the right angle of the triangle forms the base 236 of the second motor mount 233. The second mirror surface 234 is parallel to, supported by and coupled to the rectangular face opposite to the right angle of the triangle. The face opposite the right angle is thus at an angle γ to the face that forms the second base 236 of the second motor mount 233, that is, at an angle (90−γ) to the first axis. In some examples, the angle γ may be in the range of substantially 0° to 15°. Using a larger angle may constrain the ability to reduce the size of the first mirror surface 224 and of the second mirror surface 234 and may adversely impact the amount of returned radiation 280 (described below) that may be captured by the sensor 200 for use by the detector 250.

In some non-limiting examples, the projection of the first axis 225 of the first motor shaft 222 in the plane of the sensor 200 and the projection of the second axis 235 of the second motor shaft 232 are parallel to one another but not necessarily collinear.

The second axis 235 of the second motor shaft 232 lies within the plane of the sensor 200 and with the reflected launch beam 281 defines an acute angle δ. The values of the angles β and δ define the shape of the ovoid-cone scan fill rosette pattern (discussed below) ultimately provided by the sensor 200. Provided that the angles β and δ are of substantially equal value, the rosette pattern will be substantially without voids. However, if they are substantially different in value, there may be a void created. Suitable selection of the relative rotation speeds of the first motor shaft 222 and of the second motor shaft 232 may increase the fill factor of the rosette pattern. In some examples, the angle δ is 45°. Changing the angles β and δ to be substantially greater or less than 45° may introduce a bias in the FOV to one side, which may in some non-limiting examples, may be undesirable.

The second redirecting assembly 230 is positioned such that the first reflected launch beam 271, which is reflected off the first mirror surface 224 and proceeds unimpeded thereafter, impinges on the second mirror surface 234. Thus, as the second motor 231 rotates the second motor shaft 232, the second mirror surface 234 oscillates at the angle γ about the second axis 235 of the second motor shaft 232, so that the first reflected launch beam 271 impinges upon the second mirror surface 234 and is reflected at an angle (90±γ) relative to the second axis 235 outward in a second reflected launch beam 272 toward the target 10. The amount of oscillation depends upon the angle γ. The bearing of the second reflected launch beam 272 depends in part upon the instantaneous rotational angle of the first mirror surface 224 (which dictates the angle of incidence of the first reflected launch beam 271 on the second mirror surface 234) and upon the instantaneous rotational angle of the second mirror surface 234.

In some non-limiting examples, the second redirecting element may be a refractive element (not shown) that causes the first reflected launch beam 271 to be refracted at an angle (90±γ) relative to the second axis 235 in the second reflected launch beam 272.

Like with the first mirror assembly 220, if the incident beam (in this case, the first reflected launch beam 271) were to impinge at a constant spot and at a constant angle, over one revolution of the second motor shaft 232, the reflected beam (in this case, the second reflected launch beam 272) would describe a (pulsed) hollow-shell right ovoid-cone FOV. However, because the first reflected launch beam 271 does not impinge at a constant spot, but rather scribes a hollow-shell right ovoid-cone on the surface of the second mirror surface 234, over one revolution of the second motor shaft 232, the second reflecting launch beam 272 describes a rosette pattern in the FOV that represents a solid or filled ovoid-cone, some or all of which may impinge on the target 10. Because the second motor shaft 232 lies in the plane of the sensor 200, the rosette pattern described is of an elliptical solid ovoid-cone FOV in azimuth and elevation, normal to the plane of the sensor 200, where the plane of the sensor 200 is defined as extending in the azimuthal direction.

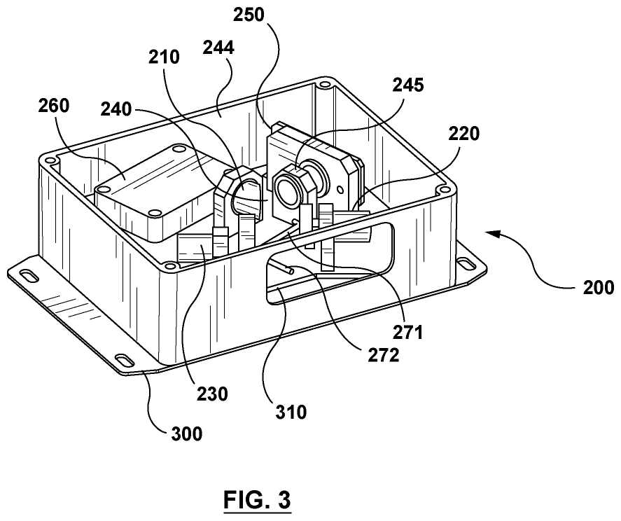

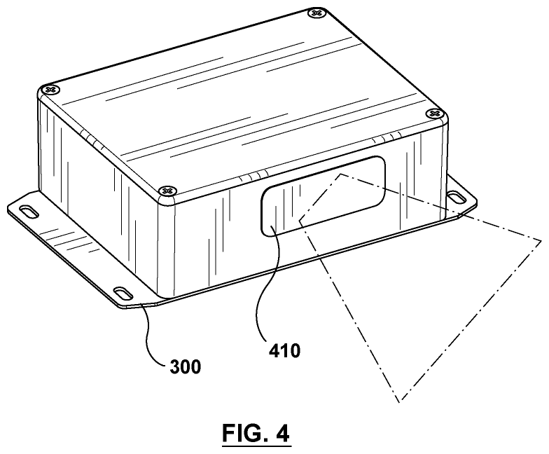

Turning now to FIG. 3, there is shown an example of the sensor 200 within an enclosure 300. The enclosure 300 comprises an enclosure aperture 310, in a lateral face thereof, through which the second reflected launch beam 272 may exit the enclosure 300. The enclosure aperture 310 is sized to substantially permit the launch beam 272 to occupy the entire available FOV. FIG. 4 shows the enclosure 300 where the enclosure aperture 310 is fitted with a radiation-permeable aperture cover 410, comprising a material that is transparent at the frequency of the launch beam 272, including, without limitation, any one or more of acrylic, polycarbonate, glass and/or crystal, to protect the components of the sensor 200 physically and from dust and other contaminants and showing the FOV emanating from the enclosure 300 through the aperture cover 410. It may be seen that in some non-limiting examples, the major axis of the ellipse of the rosette pattern is parallel to the plane of the sensor 200 and the minor axis is transverse thereto.

Adjusting the angles α and γ and the angles β and δ as well as the diameters of the first mirror surface 224 and of the second mirror surface 234, will vary the FOV achievable. In some examples, a 60°×40° elliptical FOV (azimuth×elevation) may be achieved by the sensor 200.

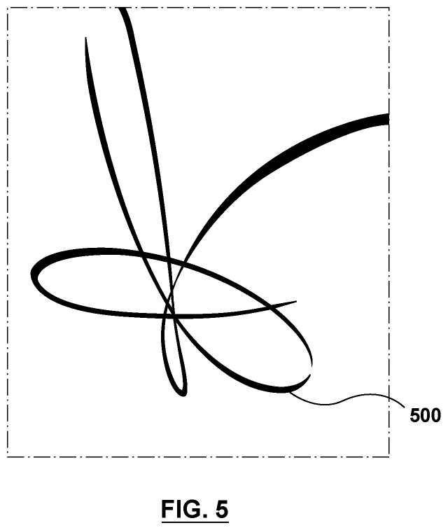

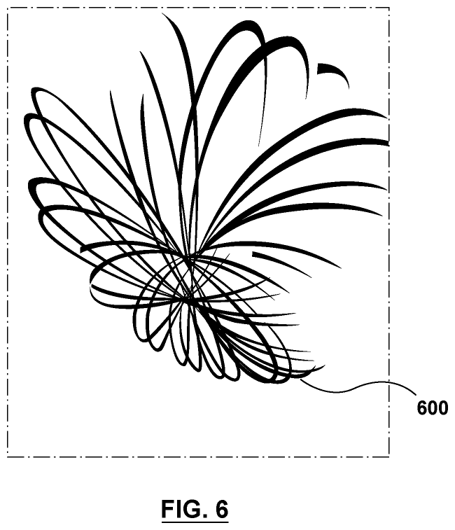

FIGS. 5 and 6 illustrate this concept. In these figures, traces of the second reflected launch beam 272 have been recorded for a number of simultaneous rotations of the first motor shaft 222 and of the second motor shaft 232 as they impinge upon a surface. In both figures, a continuous wave launch beam 271 was used. The trace 500 of FIG. 5 reflects a smaller number of rotations than the trace 600 of FIG. 6. What can be seen is that substantially elliptical curves are traced, reflecting the ovoid created by the rotation of the first mirror surface 224, and these curves are rotated about the FOV by the simultaneous and independent rotation of the second mirror surface 234. It may be seen from consideration of the trace 500, that as the number of rotations increases, a more complete rosette develops, progressively filling the FOV until a steady state rosette pattern is ultimately achieved, with numerous rotations.

The exact relationship between the rotational speeds of the first motor shaft 222 and of the second motor shaft 232 and/or the phase relationship if any between them impact the form and density of the fill pattern.

The first reflected launch beam 271 may, as a result of the rotation of the first mirror surface 234, impinge at various points, defining an ovoid, on the second mirror surface 234. The second mirror surface 234 is sized to ensure that a substantial portion of the return radiation 280 reflected off the target 10 upon impingement thereon by the second reflected launch beam 272 will be presented, after redirection by the first mirror surface 224, to the third redirecting element 240, so that a maximum amount of energy is recovered for processing by the detector 250 to permit detection and ranging of the target 10 as discussed below. The larger the angle α of the first mirror surface 224, the larger will be the size of the second mirror surface 234. It will be appreciated that the distance between the first mirror surface 224 and the second mirror surface 234 may impact the size of the second mirror surface 234.

Subject to such constraints as well as power and/or cooling considerations, those having ordinary skill in the relevant art will appreciate that there are no practical limits to how large and/or how small the sensor 200 may be made.

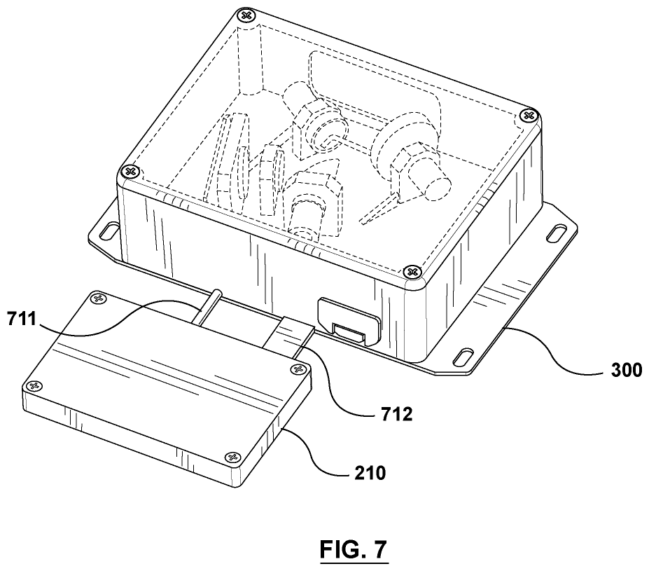

In some examples, the enclosure 300 of the sensor 200 may be further reduced in size by housing the beam source 210 outside the enclosure 300, as shown in FIG. 7. In such circumstances, the launch beam 270 is passed into the enclosure 300 by a fibre 711 and data from the beam source 210 may be sent to the receiving unit 260 by means of a ribbon cable 712.

Thus the operation of the launch portion of the sensor 200 may now be described. It will be appreciated that while the operation of the detection portion of the sensor 200 is being described independently of the operation of the launch portion of the sensor 200, both the launch portion and the detection portion operate simultaneously and employ common components.

The first mirror surface 224 is rotated in a first direction and at a constant rotational rate and the second mirror surface 234 is independently rotated in a second direction and at a constant rotational rate. The first and second directions may be the same or different.

The beam source 210 emits a (pulsed) launch beam 270 and provides data to the receiving unit 260 along signal line 212 by which the launch beam 270 may be correlated with corresponding returns detected in the detection portion (described below) of the sensor 200 to determine the range R to the target 10. The launch beam 270 passes through and is conditioned by the collimator 213 and impinges at the central point of the first mirror surface 224, being reflected as the first reflected launch beam 271 that impinges on the second mirror surface 234, whereupon it is reflected as the second reflected launch beam 272 outwardly toward the target 10 in an elliptical conic rosette pattern. As described below, the launch beam 270 passes unimpeded through an aperture 242 in the third reflecting element 240, which is positioned between the beam source 210 and the first mirror surface 224.

The actual rosette pattern that will be displayed in the steady state depends upon a number of factors, including without limitation, the pulse rate, the total scan time, the rotational direction and/or frequency of the first motor shaft 222, the angle α of the first mirror surface 224, the rotational direction and/or frequency of the second motor shaft 232, the angle γ of the second mirror surface 234, the separation of the first mirror surface 224 and the second mirror surface 234 and the range of the target.

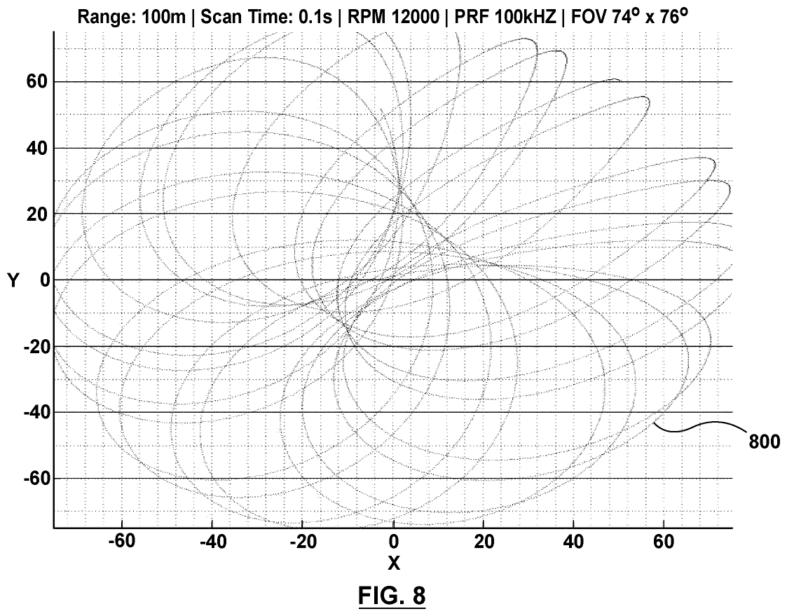

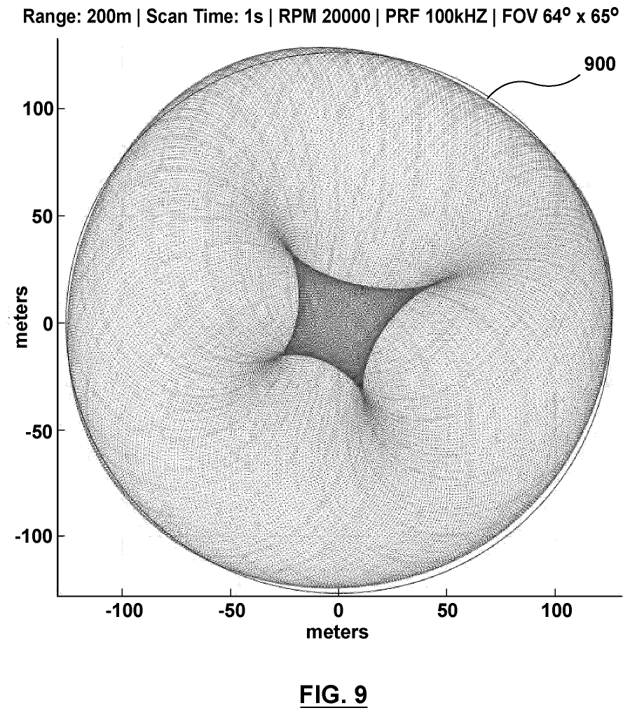

FIGS. 8 and 9 show non-limiting example simulations of scans made using the launch portion of the sensor 200 using different combinations of such parameters.

By way of non-limiting example, the scan 800 shown in FIG. 8 reflects a PRF of 100 kHz, a scan time of 0.1 s, a rotational frequency for the first motor shaft 222 of 2,211 RPM, an angle α of the first mirror surface of 10°, a rotational frequency for the second motor shaft 232 of 12,000 RPM, an angle γ of the second mirror surface 234 of 12°, a mirror separation of 1.4242 cm and a target range of 100 m. The ratio of the rotational frequency of the second motor shaft 232 relative to the rotational frequency of the first motor shaft is thus 5.4267.

By way of non-limiting example, the scan 900 shown in FIG. 9 reflects a pulse rate of 100 kHz, a scan time of 1.0 s, a rotational frequency for the first motor shaft 222 of 1,883 RPM, an angle α of the first mirror surface of 9.4°, a rotational frequency for the second motor shaft 232 of 20,000 RPM, an angle γ of the second mirror surface 234 of 9.4°, a mirror separation of 2.8284 cm and a target range of 200 m. The ratio of the rotational frequency of the second motor shaft 232 relative to the rotational frequency of the first motor shaft is thus 10.62. The scan 900 provides a FOV of 64°×65°.

Turning now to the detection portion of the sensor 200, the impingement on the target 10 of at least a portion of the rosette pattern in the FOV generated by the second reflected launch beam 272 will be reflected by the target 10 as a wall of return radiation 280 that is, in general, the reverse of the second reflected launch beam 272.

The directionality and intensity of the return radiation 280 may be impacted, to a greater or lesser degree by any one or more of, without limitation:
the reflectivity of the target 10;
the physical orientation of the target 10 with respect to the launch beam 270;
the size of the target 10;
the general and/or localized topography of the target 10;
the range R of the target 10 from the sensor 200; and
other factors, including without limitation, the presence and/or density of obscurants between the sensor 200 and the target 10.

As a result, some but potentially not all, of the return radiation 280, which is reflected by the target 10 will impinge upon the second mirror surface 234.

In some respects, the second mirror surface 234 may be said to “sample” the wall of return radiation 280. The parameters of the sensor 200, including without limitation, the FOV, the angles α, β, γ and δ, the size of the first mirror surface 224 and of the second mirror surface 234 and the distance between them, may be selected to maximize the likelihood that a majority of the return radiation 280 will so sampled by the second mirror surface 234.

Thus, as the second motor 231 rotates the second motor shaft 232, the second mirror surface 234 oscillates at the angle γ about the axis 235 of the second motor shaft 232, so that a sampling of the return radiation 280 impinges upon the second mirror surface 234 and is reflected in a first reflected return column 281. The amount of oscillation depends upon the angle γ. The bearing of the first reflected return column 281 depends in part upon the instantaneous rotational angle of the second mirror surface 234.

If the incident radiation (in this case, the return radiation 280) were to impinge at a constant spot and at a constant angle, over one revolution of the second motor shaft 232, the reflected radiation (in this case, the first reflected return column 281 would describe a (pulsed) right cone shell. However, because the second reflected launch beam 272 will have been directed in a rosette pattern throughout the FOV, such that the return radiation 280 will have moved in response, and because the path of return radiation 280 may be affected by any topographical features of the target 10 upon which the second reflected launch beam 280 impinges) the pattern described by the first reflecting return column 281 will necessarily be complex and incapable of simplistic description. Rather, some or all of the first reflecting return column 281 may impinge upon the first mirror surface 224.

In some respects, the first mirror surface 224 may be said to further “sample” the first reflected return column 281. The parameters of the sensor 200, including without limitation, the FOV, the angles α, β, γ and δ, the size of the first mirror surface 224 and of the second mirror surface 234 and the distance between them, may be selected to maximize the likelihood that a majority of the first reflected return column 281 will be so sampled by the first mirror surface 224.

The first mirror surface 224 is sized to ensure that a sufficient amount of the first reflected return column 281 is reflected thereon toward the beam splitter 240 to permit detection and ranging of the target 10. The first mirror surface 224 is sized such that when viewed from the direction of the third redirecting element 240, it appears to substantially fill and in some non-limiting examples overfill the view thereof. It will be appreciated that the distance between the second mirror surface 234 and the first mirror surface 224 may impact the size of the first mirror surface 224.

The first mirror assembly 220 is positioned such that the first reflected return column 281, which is reflected off the second mirror surface 234 and proceeds unimpeded thereafter, impinges upon the first mirror surface 224. Thus, as the first motor 221 rotates the first motor shaft 222, the first mirror surface 224 oscillates at the angle α about the axis 225 of the first motor shaft 222 and the first reflected return column 281 impinges upon the first mirror surface 224 and is reflected inward as second reflected return column 282 toward the beam splitter 240. The amount of oscillation depends upon the angle α. The bearing of the second reflected return column 282 depends in part upon the instantaneous rotational angle of the second mirror surface 234 (which dictates, in part, the angle of incidence of the first reflected return column 281 on the first mirror surface 224) and upon the instantaneous rotational angle of the first mirror surface 224. If the incident radiation (in this case, the first reflected return column 281) were to impinge at a constant spot and at a constant angle, over one revolution of the first motor shaft 222, the reflected radiation (in this case, the second reflected return column 282) would describe a (pulsed) right cone shell. However, because the second reflected launch beam 272 will have been directed in a rosette pattern throughout the FOV, such that the return radiation 280 will have moved in response, and because the path of return radiation 280 will be affected by any topographical features of the target 10 upon which the second reflected launch beam 280 impinges) the pattern described by the second reflecting return column 282 will necessarily be complex and incapable of simplistic description. Nevertheless, some or all of such pattern may impinge on the third redirecting element 240.

The third redirecting element 240 is a fixed optical element interposed between the laser source 210 and the first motor assembly 220 and having an optical axis 242 collinear with the beam axis 215. The third redirecting element 240 is oriented facing the first mirror surface 224 and configured to redirect radiation incident thereon at an angle to the beam axis 215, with a small aperture 241 extending therethrough along the optical axis 242.

In some examples, the third redirecting element 240 is a substantially planar, mirrored surface oriented at an angle to the optical axis 242. In some examples, the third redirecting element 240 is an offset segment of a parabolic reflecting and focusing element (not shown) configured to redirect radiation thereon at an angle to the optical axis 242. In some examples, the third redirecting element 240 is a refractive element (not shown) configured to redirect the radiation incident thereon (in a direction opposite to that of the launch beam 270) at an angle to the optical axis 242. In some examples, the angle is substantially 45°.

However implemented, the bore of the aperture 241 within the third redirecting element 240 is sized to ensure that the launch beam 270 may pass therethrough unimpeded, while substantially minimizing the amount of the second reflected return column 282 that will pass therethrough. Thus, the launch beam 270 passes through the aperture 241 to impinge unimpeded upon the first mirror surface 224, while most if not substantially all of the second reflected return column 282 is reflected by the redirecting element 240 as a third redirected return column 283 toward the detector 250.

In some respects, the third redirecting element 240 may be said to further “sample” the second reflected return column 282. The parameters of the sensor 200, including without limitation, the FOV, the angles α, β, γ and δ, the size of the first mirror surface 224 and of the second mirror surface 234 and the distance between them, as well as the distance between the first mirror surface 224 and the third redirecting element 240, the size and angle of the third redirecting element 240 and the size of the aperture 241, may be selected to maximize the likelihood that a majority of the second reflected return column 282 will be so sampled by the third redirecting element 240.

In some examples, a filter 243 and/or a focusing lens 244 is interposed along the path of the third redirected return column 283. If a focusing lens 244 is employed, the third redirected return column 283 is focused as a focused beam 284 toward a focal point proximate to a surface of the detector 250. In some examples, the focusing lens 244 may be dispensed with, if the third redirecting element 240 is a parabolic reflecting and focusing element (not shown) or a refractive element (not shown), in which case, the third redirected return column 283 itself constitutes the focused beam 284 focused toward the focal point proximate to the surface of the detector 250.

If employed, the filter 243 and/or the focusing lens 244 are sized to accept and pass therethrough, substantially all of the third redirected return column 283, so that there is no “sampling” performed thereby.

Eventually, the focused beam 284 strikes the detector 250.

The detector 250 detects the impingement of the focused beam 284 thereon. In some examples, the detector 250 may be an avalanche photodiode (APD), a PIN Photodiode and/or or a receiving fibre connected thereto. The detector 250 is coupled to the receiver unit 260 such that the receiver unit 260 is able to correlate the emission of the launch beam 270 with the receipt of the focused beam 284 corresponding thereto by the detector 250 so as to determine a range R to the target 10

In some non-limiting examples, the detector 250 determines a time when the focused beam 284 is detected at the detector 250. The receiver unit 260 then correlates the time that the launch beam 270 is emitted with the time at which the corresponding signal is detected at the detector 250, from which the receiver unit 260 may determine a TOF to and from the target 10, from which the range R thereto may be determined.

In some non-limiting examples, the detector 250 detects, by way of heterodyne phase detection, a phase of the focused (CW) beam 284, which in some non-limiting examples would be a FMCW beam. The receive unit 260 then correlates the phase at which the launch beam 270 is emitted with the phase at which the corresponding signal is detected at the detector 250, from which the receiver unit 260 may determine a heterodyne phase difference relative to the corresponding portion of the launch beam 270, from which the range R to the target 10 may be determined, although it will be appreciated that the specific configuration in such case would be different and may involve different and/or additional components from that shown in FIG. 2 and as described herein.

The receiver unit 260 is coupled to the beam source 210 and the detector 250 and accepts data therefrom that allows it to determine the range R to the target 10.

In some examples, the receiver unit 260 may comprise and/or be implemented by a field-programmable gate array (FPGA) coupled to the beam source 210 and the detector 250.

In some examples, the data obtained by the receiver unit 260 allows the receiver unit 260 to derive the TOF between when the (pulsed) launch beam 270 is emitted by the beam source 210 and when the (pulsed) focused beam 284 corresponding thereto is detected at the detector 250, from which the range R to the target 10 may be determined.

The mechanism by which the TOF is determined for pulsed beams is well known. In some examples the range R may be determined from the TOF by Equation 1:

R=τc/2 (where τ is the measured TOF and c is the speed of light) (1)

In some examples, the data obtained by the receiver unit 260 allows the receiver unit 260 to derive a phase difference between the (CW) launch beam 270 that is emitted by the beam source 210 and the (CW) focused beam 284 corresponding thereto detected by way of heterodyne phase detection at the detector 250, from which the range R to the target 10 may be determined.

The mechanism by which the phase difference is determined for FMCW beams is well known.

Thus, the operation of the detection portion of the sensor 200 may now be described. It will be appreciated that while the operation of the detection portion of the sensor 200 is being described independently of the operation of the launch portion of the sensor 200, both the launch portion and the detection portion operate simultaneously and employ common components.

The first mirror surface 224 is rotated in a first direction and at a constant rotational rate and the second mirror surface 234 is independently rotated in a second direction and at a constant rotational rate. The first and second directions may be the same or different. It will be appreciated that this is the same as in the operation of the launch portion of the sensor 200, described above.

Some of the return radiation 280, which comprises reflections of the second reflected launch beam 272 off the surface of the target 10, impinges on the second mirror surface 234, being reflected as the first reflected return column 281 that impinges on the first mirror surface 224, whereupon it is reflected as the second reflected return column 282 inwardly toward the third redirecting element 240. A portion of the second reflected return column 282 is redirected by the third redirecting element 240, optionally through the filter 243 and/or focusing lens 244, and is focused as a focused beam 284 toward a focal point proximate to the surface of the detector 250. The detector 250 detects the focused beam 284 and provides data to the receiving unit 260 by which the focused beam 284 may be correlated with corresponding portions of the launch beam 270 in the launch portion (described above) of the sensor 200 to determine the range R to the target 10.

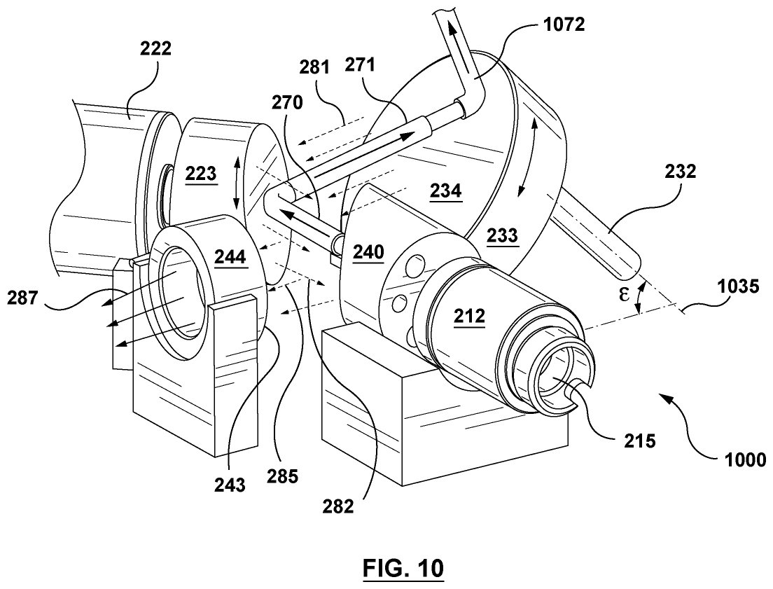

Turning now to FIG. 10, there is shown a perspective schematic view of a second example of a multiple mirror monostatic scanning LIDAR optical ranging sensor according to the present disclosure. The sensor, shown generally at 1000, comprises the same components as the sensor 200 of FIG. 2. However, whereas the beam axis 215, the first axis 225 and the second axis 235 of the sensor 200 all lay in the plane of the sensor 200, in the sensor 1000, the second axis 1035 of the sensor 1000 lies beyond the plane of the sensor 1000, defined by the beam axis 215 and the first axis 225.

Thus, while the second motor mount 233 continues to support mirror surface 234 thereon at an angle γ to the second base 236 of the second motor mount 233, and while the second axis 1035 of the second motor shaft 232 continues to define an acute angle δ (in plan) that substantially matches the angle β, the second axis 1035 also defines an angle E out of the plane of the sensor 1000. In some example, the second motor shaft 232 lies below the plane of the sensor 1000, in which case, the second reflected launch beam 1072 now extends substantially upward of the plane of the sensor 1000.

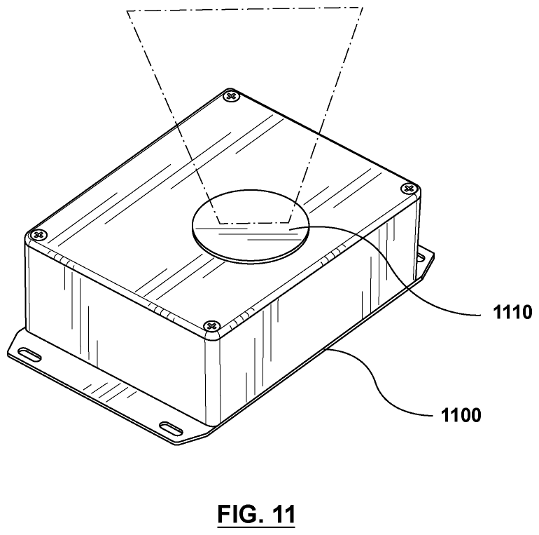

This is shown in FIG. 11, in which the enclosure 1100 of the sensor 1000 now has an aperture 1110 on an upper face thereof, rather than on a lateral face thereof, as in the case of FIG. 3.

In some examples, the angle E may be substantially 45°, in which case the second reflected launch beam 1072 is reflected substantially 90° relative to the plane of the sensor 1000.

Additionally, rather than defining a rosette pattern that is of an elliptical solid ovoid-cone FOV normal to the plane of the sensor 200, the sensor 1000 now defines a rosette pattern that is a conical solid ovoid-cone FOV.

Adjusting the angles α and γ and the angles β, δ and ε as well as the diameters of the first mirror surface 224 and of the second mirror surface 234, will vary the FOV achievable. In some examples, a 75° conical FOV may be achieved by the sensor 1000.

It will be apparent that various modifications and variations may be made to the embodiments disclosed herein, consistent with the present disclosure, without departing from the spirit and scope of the present disclosure.

In the foregoing disclosure, for purposes of explanation and not limitation, specific details are set forth such as particular architectures, interfaces, techniques, etc. in order to provide a thorough understanding of the present disclosure. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present disclosure.

The present disclosure can be implemented in digital electronic circuitry, or in computer hardware, firmware, software, or in combination thereof. Apparatus of the disclosure can be implemented in a computer program product tangibly embodied in a machine-readable storage device for execution by a programmable processor; and methods and actions can be performed by a programmable processor executing a program of instructions to perform functions of the disclosure by operating on input data and generating output.

The disclosure can be implemented advantageously on a programmable system including at least one input device, and at least one output device. Each computer program can be implemented in a high-level procedural or object-oriented programming language or in assembly or machine language, if desired; and in any case, the language can be a compiled or interpreted language. Further, the foregoing description of one or more specific embodiments does not limit the implementation of the invention to any particular computer programming language, operating system, system architecture or device architecture.

The processor executes instructions, codes, computer programs, scripts which it accesses from hard disk, floppy disk, optical disk (these various disk based systems may all be considered secondary storage), ROM, RAM, or the network connectivity devices. Multiple processors may be present. Thus, while instructions may be discussed as executed by a processor, the instructions may be executed simultaneously, serially, or otherwise executed by one or multiple processors.

When provided by a processor, the functions may be provided by a single dedicated processor, by a single shared processor, or by a plurality of individual processors, some of which may be shared or distributed. The functions of the various elements including functional blocks labelled as “modules”, “processors” or “controllers” may be provided through the use of dedicated hardware, as well as hardware capable of executing software in association with appropriate software with sufficient processing power, memory resources, and network throughput capability to handle the necessary workload placed upon it. Moreover, explicit use of the term “module”, “processor” or “controller” should not be construed to refer exclusively to hardware capable of executing software, and may include, without limitation, digital signal processor (DSP) hardware, read-only memory (ROM) for storing software, random access memory (RAM) and non-volatile storage.

Suitable processors include, by way of example, both general and specific microprocessors. Generally, a processor will receive instructions and data from a read-only memory or a random access memory. Generally, a computer will include one or more mass storage devices for storing data file; such devices include magnetic disks and cards, such as internal hard disks, and removable disks and cards; magneto-optical disks; and optical disks. Storage devices suitable for tangibly embodying computer program instructions and data include all forms of volatile and non-volatile memory, including by way of example semiconductor memory devices, such as EPROM, EEPROM, and flash memory devices; magnetic disks such as internal hard disks and removable disks; magneto-optical disks; CD-ROM and DVD-ROM disks; and buffer circuits such as latches or flip flops. Any of the foregoing can be supplemented by, or incorporated in ASICs (application-specific integrated circuits), FPGAs (field-programmable gate arrays), DSPs (digital signal processors) or GPUs (graphics processing units) including, without limitation, general purpose GPUs.

Examples of such types of computer are programmable processing systems suitable for implementing or performing the apparatus or methods of the disclosure. The system may comprise a processor, (which may be referred to as a central processor unit or CPU), which may be implemented as one or more CPU chips, and that is in communication with memory devices including secondary storage, read only memory (ROM), a random access memory, a hard drive controller, or an input/output devices or controllers, and network connectivity devices, coupled by a processor bus.

Secondary storage is typically comprised of one or more disk drives or tape drives and is used for non-volatile storage of data and as an over-flow data storage device if RAM is not large enough to hold all working data. Secondary storage may be used to store programs which are loaded into RAM when such programs are selected for execution. The ROM is used to store instructions and perhaps data which are read during program execution. ROM is a non-volatile memory device which typically has a small memory capacity relative to the larger memory capacity of secondary storage. The RAM is used to store volatile data and perhaps to store instructions. Access to both ROM and RAM is typically faster than to secondary storage.

I/O devices may include printers, video monitors, liquid crystal displays (LCDs), touch screen displays, keyboards, keypads, switches, dials, mice, track balls, voice recognizers, card readers, paper tape readers, or other well-known input devices.

The network connectivity devices may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) or global system for mobile communications (GSM) radio transceiver cards, and other well-known network devices. These network connectivity devices may enable the processor to communicate with an Internet or one or more intranets. The network connectivity devices may also include one or more transmitter and receivers for wirelessly or otherwise transmitting and receiving signal as are well known. With such a network connection, it is contemplated that the processor might receive information from the network, or might output information to the network in the course of performing the above-described method steps.

Such information, which is often represented as data or a sequence of instructions to be executed using the processor for example, may be received from and outputted to the network, for example, in the form of a computer data baseband signal or signal embodied in a carrier wave. The baseband signal or signal embodied in the carrier wave generated by the network connectivity devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several well known methods.

Moreover, although some embodiments may include mobile devices, not all embodiments are limited to mobile devices; rather, various embodiments may be implemented within a variety of communications devices or terminals, including handheld devices, mobile telephones, personal digital assistants (PDAs), personal computers, audio-visual terminals, televisions and other devices.

While example embodiments are disclosed, this is not intended to be limiting. Rather, the general principles set forth herein are considered to be merely illustrative of the scope of the present disclosure and it is to be further understood that numerous changes covering alternatives, modifications and equivalents may be made without straying from the scope of the present disclosure, as defined by the appended claims.

For example, the various elements or components may be combined or integrated in another system or certain features may be omitted, or not implemented. Also, techniques, systems, subsystems and methods described and illustrated in the various embodiments as discrete or separate may be combined or integrated with other systems, modules, techniques, or methods without departing from the scope of the present disclosure. Other examples of changes, substitutions, and alterations are easily ascertainable and could be made without departing from the spirit and scope disclosed herein.

In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

In some instances, detailed descriptions of well-known devices, circuits, and methods are omitted so as not to obscure the description of the present disclosure with unnecessary detail. All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated that block diagrams reproduced herein can represent conceptual views of illustrative components embodying the principles of the technology.

While the present disclosure is sometimes described in terms of methods, a person of ordinary skill in the art will understand that the present disclosure is also directed to various apparatus including components for performing at least some of the aspects and features of the described methods, be it by way of hardware components, software or any combination of the two, or in any other manner.

Certain terms are used throughout to refer to particular components. Manufacturers may refer to a component by different names. Use of a particular term or name is not intended to distinguish between components that differ in name but not in function.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances. In particular, the term “exemplary” should not be interpreted to denote or confer any laudatory, beneficial or other quality to the expression with which it is used, whether in terms of design, performance or otherwise.

Directional terms such as “upward”, “downward”, “left” and “right” are used to refer to directions in the drawings to which reference is made unless otherwise stated. Similarly, words such as “inward” and “outward” are used to refer to directions toward and away from, respectively, the geometric center of a device, area or volume or designated parts thereof. Moreover, all dimensions described herein are intended solely to be by way of example for purposes of illustrating certain embodiments and are not intended to limit the scope of the disclosure to any embodiments that may depart from such dimensions as may be specified.

The terms “couple” or “communicate” in any form are intended to mean either a direct connection or indirect connection through some interface, device, intermediate component or connection, whether electrically, mechanically, chemically, or otherwise.

References in the singular form include the plural and vice versa, unless otherwise noted.

The purpose of the Abstract is to enable the relevant patent office or the public generally, skill in the art who are not familiar with patent or legal terms or phraseology, to quickly determine from a cursory inspection the nature of the technical disclosure. The Abstract is neither intended to define the scope of this disclosure, which is measured by its claims, nor is it intended to be limiting as to the scope of this disclosure in any way.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances. In particular, the term “exemplary” should not be interpreted to denote or confer any laudatory, beneficial or other quality to the expression with which it is used, whether in terms of design, performance or otherwise.

The terms “couple” and “communicate” in any form are intended to mean either a direct connection or indirect connection through some interface, device, intermediate component or connection, whether electrically, mechanically, chemically, or otherwise.

Directional terms such as “upward”, “downward”, “left” and “right” are used to refer to directions in the drawings to which reference is made unless otherwise stated. Similarly, words such as “inward” and “outward” are used to refer to directions toward and away from, respectively, the geometric center of the device, area or volume or designated parts thereof.

Moreover, all dimensions described herein are intended solely to be by way of example for purposes of illustrating certain embodiments and are not intended to limit the scope of the disclosure to any embodiments that may depart from such dimensions as may be specified.

References in the singular form include the plural and vice versa, unless otherwise noted.

As used herein, relational terms, such as “first” and “second”, and numbering devices such as “a”, “b” and the like, may be used solely to distinguish one entity or element from another entity or element, without necessarily requiring or implying any physical or logical relationship or order between such entities or elements.

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated that block diagrams reproduced herein can represent conceptual views of illustrative components embodying the principles of the technology.

The purpose of the Abstract is to enable the relevant patent office or the public generally, and specifically, persons of ordinary skill in the art who are not familiar with patent or legal terms or phraseology, to quickly determine from a cursory inspection, the nature of the technical disclosure. The Abstract is neither intended to define the scope of this disclosure, which is measured by its claims, nor is it intended to be limiting as to the scope of this disclosure in any way.

The structure, manufacture and use of the presently disclosed embodiments have been discussed above. While example embodiments are disclosed, this is not intended to be limiting the scope of the presently described embodiments. It should be appreciated, however that the present disclosure, which is described by the claims and not by the implementation details provided, which can be modified by omitting, adding or replacing elements with equivalent functional elements, provides many applicable inventive concepts that may be embodied in a wide variety of specific contexts. The specific embodiments discussed are merely illustrative of specific ways to make and use the disclosure, and do not limit the scope of the present disclosure. Rather, the general principles set forth herein are considered to be merely illustrative of the scope of the present disclosure.

In particular, features from one or more of the above-described embodiments may be selected to create alternative embodiments comprised of a sub-combination of features that may not be explicitly described above. In addition, features from one or more of the above-described embodiments may be selected and combined to create alternative embodiments comprised of a combination of features that may not be explicitly described above. Features suitable for such combinations and sub-combinations would be readily apparent to persons skilled in the art upon review of the present application as a whole. The subject matter described herein and in the recited claims intends to cover and embrace all suitable changes in technology. Further, the various elements or components may be combined or integrated in another system or certain features may be omitted, or not implemented. Also, techniques, systems, subsystems and methods described and illustrated in the various embodiments as discrete or separate may be combined or integrated with other systems, modules, techniques, or methods without departing from the scope of the present disclosure. Other examples of changes, substitutions, and alterations are easily ascertainable and could be made without departing from the scope disclosed herein.

It will be apparent that various modifications and variations covering alternatives, modifications and equivalents will be apparent to persons having ordinary skill in the relevant art upon reference to this disclosure and the practice of the embodiments disclosed therein and may be made to the embodiments disclosed herein, without departing from the present disclosure, as defined by the appended claims.

Other embodiments consistent with the present disclosure will be apparent from consideration of the specification and the practice of the disclosure disclosed herein. Accordingly the specification and the embodiments disclosed therein are to be considered examples only, with a true scope and spirit of the disclosure being disclosed by the following numbered claims:

1.-26. (canceled)

27. A head for directing energy radiated from a source along a beam axis to a coordinate in a field of view (FOV) defined by at least one of azimuth and elevation, comprising:
a first energy-redirecting element fully rotatable about a first axis that is at a first angle relative to the beam axis, for receiving the radiated energy incident thereon along the beam axis and redirecting it at a second angle to the first axis as it is rotated; and
a second energy-redirecting element fully and independently rotatable, in at least one of direction and rate relative to the first energy-redirecting element, about a second axis that is at a third angle relative to the beam axis, for receiving the redirected energy incident thereon and further redirecting it at a fourth angle to the second axis as it is rotated, in a direction within the FOV.

28. A head according to claim 27, wherein the first angle is substantially equal to the third angle.

29. A head according to claim 28, wherein the first angle is substantially 45°.

30. A head according to claim 27, wherein the second angle is substantially between 0° and 15°.

31. A head according to claim 27, wherein the third angle is substantially 45°.

32. A head according to claim 27, wherein the fourth angle is substantially between 0° and 15°.

33. A head according to claim 27, wherein the second axis lies in an azimuthal plane defined by the beam axis and the first axis.

34. A head according to claim 33, wherein the FOV extends substantially 60° in azimuth.

35. A head according to claim 33, wherein the FOV extends substantially 40° in elevation.

36. A head according to claim 27, wherein the second axis is at a fifth angle relative to the plane.

37. A head according to claim 36, wherein the fifth angle is substantially 45°.

38. A head according to any of claim 36, wherein the FOV extends substantially 75° in at least one of azimuth and elevation.

39. A head according to claim 27, wherein the first energy-redirecting element is a first mirror surface.

40. A head according to claim 27, wherein the second energy-redirecting element is a second mirror surface.

41. A head according to claim 27, wherein the first energy-redirecting element is independently rotatable in both direction and rate relative to the second energy-redirecting element.

42. A head according to claim 27, wherein the energy from the source passes unimpeded through an aperture in a third energy-redirecting element positioned between the source and the first energy-redirecting element.

43. A head according to claim 42, wherein at least some of the energy redirected by the second energy-redirecting element is returned and impinges upon the second energy-redirecting element to be redirected for impingement upon the first energy-redirecting element to be further redirected for impingement upon the third energy-redirecting element, whereupon it is redirected toward a detector.

44. A head according to claim 42, wherein the third energy-redirecting element is at least one of a third mirror surface and a refractive element.

45. A head according to claim 44, wherein the source and the detector are each coupled to a receiving unit whereby data from the detector is correlated with corresponding data from the source to determine a range from the head to a target within the FOV upon which the energy redirected by the second energy-redirecting element has impinged and been returned to the head.

46. A method of directing energy, radiated from a source along a beam axis, to a coordinate in a field of view (FOV) defined by at least one of azimuth and elevation, comprising actions of:
rotating a first energy-redirecting element completely about a first axis that is at a first angle relative to the beam axis;
directing the energy from the source onto the first energy-redirecting element;
redirecting the energy incident on the first energy-redirecting element, at a second angle to the first axis, toward a second energy-redirecting element;
independently rotating, in at least one of direction and rate relative to the first energy-redirecting element, the second energy-redirecting element completely about a second axis that is at a third angle relative to the beam axis; and
further redirecting the energy incident on the second energy-redirecting element, from the first energy-redirecting element, at a fourth angle to the second axis in a direction within the FOV.
